(19) United States
(12) Patent Application Publication
(10) Pub. No.: US 2012/0095969 A1
(43) Pub. Date: Apr. 19, 2012

(54) SYSTEM, METHOD AND COMPUTER PROGRAM PRODUCT FOR COLLECTING AND MANAGING ALLOY VERIFICATION

(76) Inventor: John Michael Bailey, Collinsville, OK (US)

(21) Appl. No.: 13/138,933

(22) PCT Filed: Apr. 28, 2010
(86) PCT No.: PCT/US2010/032852

§ 371 Date: Dec. 21, 2011

Related U.S. Application Data
(60) Provisional application No. 61/176,936, filed on May 10, 2009.

(51) Int. Cl. G06F 7/00; G06F 17/30

(52) U.S. Cl. 707/667; 707/756; 707/E17.005; 707/E17.044

(57) ABSTRACT

A system, method and computer program product include storing a representation of a mechanical system and an item type listing with parts and specifications for the parts. At least part of the representation comprising a group of parts to validate is displayed. A location of a part on the displayed representation is selected for analysis. An item type of the selected location is selected and linked to the selected location for determining analysis requirements. Analysis data from an alloy analyzer and specifications of the part is linked to the selected location of the displayed representation. On the displayed representation, a mismatch between analysis data and specifications is indicated, thereby transforming the representation to a representation comprising at least the analysis data and the specifications.

### CROSS-REFERENCE TO RELATED APPLICATIONS

The present PCT application claims priority benefit of the U.S. provisional application for patent Ser. No. 61/176,936 filed on 10 May 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the field of inspection and more specifically to a system for collecting and managing alloy verification information.

### BACKGROUND OF THE INVENTION

Proper alloy inspection and verification in piping systems, such as, but not limited to, refineries, and other types of mechanical systems helps prevent catastrophic failure due to the use of incorrect materials in the components of the system. Alloy verification identifies and analyzes all of the critical alloy components, or locations, in a system such as, but not limited to, pipes, valves, fittings, and welds for accuracy and documents the results of this analysis. The verification process also verifies that all of the locations of a system are analyzed.

Current alloy inspection and verification approaches are often tedious. One current approach is to manually create hand written results of the analysis on drawings of the system. Depending on the complexity of the system, there may be hundreds of locations to analyze per drawing in this approach and multiple copies of each drawing may be required in order to handle the large amount of data collected. The preparation needed for this approach is time consuming including gathering drawings, verifying that drawings are up to date, tagging locations on drawings, etc. In some current approaches, the results may be compiled in a spreadsheet. However, these approaches still require a large amount of preparation time and drawings for gathering the data. These current approaches also make it difficult to efficiently utilize existing data and documentation and to generally ensure that all critical components of the system are analyzed. It is therefore an objective of the present invention to provide means to better manage the alloy verification process by more efficiently organizing analysis data.

A prior art system for collecting and managing alloy verification data exists. This system assigns locations and groups of locations to barcodes that link these locations to a database of critical components on a PC. Once the analysis data, along with the barcode labels, is downloaded to the PC, an application on the PC generates a report of the accuracy of the components being verified. However, this system still requires a great deal of preparation including updating and tagging existing drawings and generating barcode labels. This system also requires the use of an existing database of general mechanical integrity data. Furthermore, reports cannot be generated until the field data is returned to a PC on which the reporting application and the previously mentioned database is installed. This means that if any locations are missed during field-testing, return trips to the field are required.

In view of the foregoing, there is a need for improved techniques for providing a management system for alloy verification data that requires a small amount of preparation and can provide reports in the field.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart illustrating an exemplary process for collecting and managing alloy verification information, in accordance with an embodiment of the present invention;

FIG. 2 illustrates an exemplary PMI mode selection menu, in accordance with an embodiment of the present invention;

FIG. 3 illustrates an exemplary map selection menu, in accordance with an embodiment of the present invention;

FIG. 4 illustrates an exemplary piping map, in accordance with an embodiment of the present invention;

FIG. 5 illustrates an exemplary PSV Map, in accordance with an embodiment of the present invention;

FIG. 6 illustrates an exemplary Pressure Vessel Map created in Pressure vessel PMI mode utilizing a vessel photo that was taken with an integrated, accessible, or connected digital camera, in accordance with an embodiment of the present invention;

FIG. 7 illustrates an exemplary Pressure Vessel Map utilizing a generic vessel drawing preloaded for the specific vessel type, in accordance with an embodiment of the present invention; and

FIG. 8 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and computer program product for collecting and managing alloy verification information is presented.

In one embodiment a system includes means for analyzing alloy composition of parts in a mechanical system, means for storing a representation of the mechanical system and an item type listing with parts and specifications for the parts, means for displaying at least part of the representation comprising a group of parts to validate, means for selecting a location of a part on the displayed representation for analysis and means for linking analysis data from the analyzing means and specifications of the part to the selected location of the displayed representation, thereby transforming the representation to a representation comprising at least the analysis data and the specifications. Other various embodiments further include means for selecting an item type of the selected location and linking to the selected location for determining analysis requirements, means for coding locations on the displayed representation for simplifying location of specific parts, means for indicating on the displayed representation a mismatch between analysis data and specifications, means for archiving the representation and linked location data, means for generating reports, means for capturing a representation of the mechanical system and means for drawing a representation of the mechanical system.

In another embodiment a method includes steps for providing an alloy analyzer for analyzing composition of parts in a mechanical system, steps for providing a computing device at least comprising computer readable memory and a display, steps for storing a representation of the mechanical system and an item type listing with parts and specifications for the parts, steps for displaying at least part of the representation comprising a group of parts to validate, steps for selecting a location of a part on the displayed representation for analysis, and steps for linking analysis data from the alloy analyzer and specifications of the part to the selected location of the displayed representation, thereby transforming the representation to a representation comprising at least the analysis data and the specifications. Other various embodiments further include steps for selecting an item type of the selected location and linking to the selected location for determining analysis requirements, steps for coding locations on the displayed representation for simplifying location of specific parts, steps for indicating on the displayed representation a mismatch between analysis data and specifications, steps for archiving the representation and linked location data, steps for generating reports, steps for capturing a representation of the mechanical system and steps for drawing a representation of the mechanical system.

In another embodiment a computer program product residing on or being distributed across one or more computer readable mediums having a plurality of instructions stored thereon which, when executed by one or more associated processors, cause the one or more processors to store a representation of a mechanical system and an item type listing with parts and specifications for the parts. At least part of the representation comprising a group of parts to validate is displayed. A location of a part on the displayed representation is selected for analysis. An item type of the selected location is selected and linked to the selected location for determining analysis requirements. Analysis data from an alloy analyzer and specifications of the part is linked to the selected location of the displayed representation. A mismatch between analysis data and specifications is indicated on the displayed representation, thereby transforming the representation to a representation comprising at least the analysis data and the specifications. Other various embodiments further include instructions causing the one or more processors to capture a representation of the mechanical system, enable drawing a representation of the mechanical system and code locations on the displayed representation for simplifying location of specific parts.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Preferred embodiments of the present invention provide a process to identify locations requiring alloy verification and to link associated alloy information during the alloy verification process. Preferred embodiments improve manageability of alloy verification projects by effectively organizing the resulting data so that the comprehensiveness of the study can easily be determined. Preferred embodiments also improve the consistency and quality of alloy validation projects for systems or groups of items requiring analysis by generally ensuring that standardized formats are developed, agreed to and utilized.

Preferred embodiments of the present invention also provide a system for collecting and managing alloy verification information comprising an alloy analyzer with a programmable interface, a digital representation or map of the group of items for alloy verification, and a customized application on the alloy analyzer that identifies and links locations on the map to alloy analysis data during the alloy verification activity. Preferred embodiments provide an alloy analyzer with a CPU or other computer controlled and programmable interface that supports functions to control the analyzer as well as provide capabilities such as, but not limited to, locating files, selecting locations on a touch screen or other digitizing method, recording specific data on a location, etc. The device according to preferred embodiments supports user input capabilities such as, but not limited to, keyboards, touch screens, barcode scanning, Bluetooth interfaces, digital cameras, and various other common PC or Pocket PC functions. The analyzer in preferred embodiments also includes data storage capabilities to contain digitized system representations, markups, alloy analysis data, reference databases, or other relevant information for the alloy verification project. Preferred embodiments of the present invention also comprise a customized application or software package that runs on the alloy analyzer to expand typical alloy analyzer analysis capabilities to include, without limitation, support for specifying alloy verification locations on a digitized representation and then associating or linking the correct alloy analysis data with the location.

A digitized representation, such as, but not limited to, a CAD drawing, a photo, a scanned sketch, etc. of the system or group of items requiring alloy verification, is utilized during the alloy verification process. In preferred embodiments this digitized representation can be generated or obtained prior to actual alloy verification activity or during the alloy verification activities. Formats of digitized orientation maps obtained prior to the alloy verification process include, without limitation, digitized CAD or hand sketched ISOs or orientation drawings, previously taken photographs, exported inspection ISOs from common mechanical integrity applications, part or component illustrations from manufacturers, or other illustrations of parts, locations or other items comprising a whole system. Common formats of digitized orientations or maps created during the field gathering process include, without limitation, electronic sketches or CAD drawings, photographs from alloy analyzer integrated or accessible digital cameras, portable or available scanners, and other methods of creating digitized orientation illustrations. Additional sources of digitized orientation illustrations include, without limitation, custom applications typically utilized on larger PC computers, tablets, or laptops where illustrations are reviewed and locations or systems for alloy verification are identified and listings of locations created prior to the alloy verification activities managed on the analyzer.

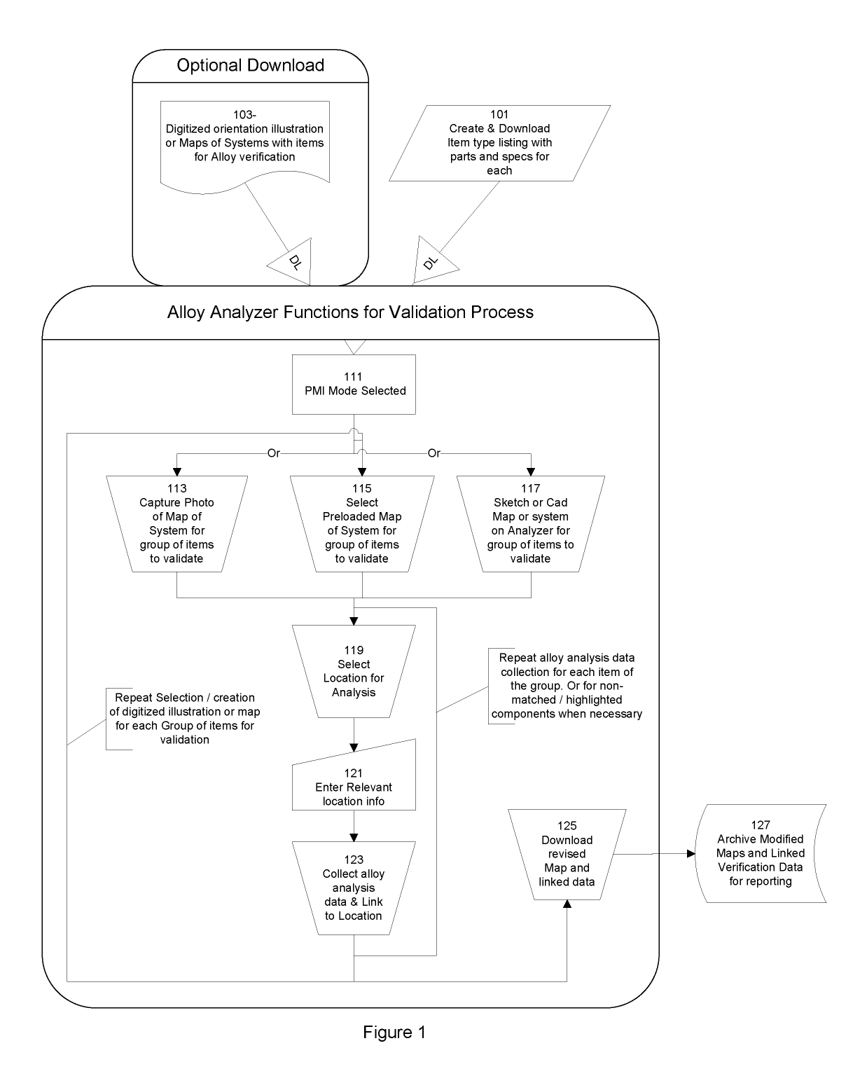

FIG. 1 is a flow chart illustrating an exemplary process for collecting and managing alloy verification information, in accordance with an embodiment of the present invention. In the present embodiment, the process comprises the primary steps of selecting the proper Positive Material Identification (PMI) mode, selecting or creating a digitized orientation map, selecting locations for alloy validation on the map, entering/verifying relevant details, and then performing the actual alloy analysis and linking collected alloy verification data to the identified location. Additional steps of reporting on inspection results are conducted at completion of the project, or may be conducted at intermediate stages of completion.

In the present embodiment, the verification process begins at step 111 where the proper PMI mode is selected on an alloy analyzer to provide the correct reference information for the types of items requiring alloy verification. Examples of possible PMI modes include, but are not limited to, piping, pressure vessel, PSV, manufactured components, and others. Reference information includes items necessary to efficiently conduct the alloy verification such as, but not limited to, default maps for specific items or groups of items, listings of typical or required analysis for specific types of items or groups, and other information that is specific to a particular type of item or component requiring alloy verification. A table of items that comprise multiple parts are defined and pre-loaded on the analyzer for the different categories of items in each particular PMI mode, so that consistent organization of all items and individual parts can be obtained during the data collection stage. This listing of items is grouped by category, which can be from 1 to 5 or more categories for grouping the alloy analysis results in a systematic way on the analyzer and in subsequent reports. The grouping by category is also intended to simplify the location of items on a map when several items are available in the listing for a specific alloy verification mode or project type, such as, but not limited to, piping, pressure vessel, PSV, or other types of systems potentially benefiting or requiring alloy verification. This item type listing is necessary prior to locating any items on the digitized illustration or map and is downloaded to the alloy analyzer prior to the verification process in step 101.

For each system or group of items identified as requiring alloy verification, a map or digitized representation is created or selected. This map can be optionally downloaded to the analyzer prior to the actual alloy verification activities in step 103, or this map can be created during the alloy verification activity. This digitized representation can be in the format of a photograph, sketch or other illustration that provides the orientation of the items requiring analysis. Being able to create the map during the verification process in the present embodiment greatly reduces the amount of preparation needed to be done prior to the process. Referring to FIG. 1 to obtain a map or digitized representation, the user of the alloy analyzer may choose to capture a photo of the system for a group of items to validate using a camera on the alloy analyzer in step 113, to select a preloaded map on the analyzer in step 115, or sketch or make a CAD drawing of a map on the analyzer in step 117. Once the digitized illustration or map is created or located from preloaded items on the analyzer, it is made immediately available for the locating of individual items or locations for analysis.

The data collection stage comprises three data collection steps including selecting a location in step 119, entering/verifying relevant data in step 121, and then collecting alloy analysis data and linking the alloy verification data that is collected to the selected location in step 123. In step 119, the locations for alloy analysis may be selected on the alloy analyzer using a touch screen, joystick, or other digitizing method which enables the user to identify an exact location on the map or digitized illustration for later reference to the alloy analysis to be performed. Depending on the map type being used, some locations could already be predefined and thus only require verification of locations and then performing analysis/linking data to each of the locations. Maps of this type could include manufacturers illustrations, standardized cad drawings, or any previously completed PMI illustrations with locations defined during the previous project or prior to the field data collection. Map types that require manual identification of locations for analysis include photos, Cad drawings, or sketches created during the data collection process, or stored pre-loaded maps that have not had locations pre-defined. As part of the selection process, additional alloy data about the location, process, item type, or other relevant details are added or verified and linked to the location in step 121. For each location, the type of item is selected and associated with the location to determine alloy analysis requirements such as, but not limited to, redundant shot requirements or multiple pieces that make up the item or location. In the present embodiment, since locations are linked on the analyzer after these steps, each location is color coded according to type of item, location or other value added criteria to facilitate simplifying location of specific items on the digitized illustration or map that is now loaded on the analyzer. The color-coding used in the present embodiment enables the user to easily locate all locations for analysis, which is sometimes difficult due to the small screen size of typical alloy analyzers. Once location data is entered, the actual alloy analysis is performed in agreement with the details entered in the previous steps while shot accuracy is verified by the technician in step 123. Problem locations or items that do not match specified or required material can also be easily highlighted with a color change or other emphasis on the analyzer such as, but not limited to, bold font or flashing for additional validation analysis while still in the field before moving on to the next step. This data is then linked to the location in step 123, and the process returns to step 119 to select another location or to reselect a problem location when necessary. When all items or locations requiring alloy verification are selected, marked, analyzed, linked, and verified, the process returns to step 113, 115 or 117 where the next group or system is chosen and a corresponding digitized illustration selected or created.

Once alloy verification data is collected and linked for all items, groups, or systems, or at intermediate stages of the project, the data is downloaded for archival and reporting purposes in step 125. In the present embodiment, reports are verified and completed on the analyzer using filters for verification of all locations by type or point or location. Reports can be viewed on the analyzer in the field while data is being collected or as a final report on the completion of data collection. The marked up digitized illustrations of locations or systems are printed, and corresponding alloy analysis details are provided in tabular or other report format. Since locations are linked on the analyzer with relevant alloy analysis data, the locations are color coded in the digitized illustration according to type of alloy verification item or location, to facilitate simplifying location of specific items on the digitized illustration or map. Problem locations or items that did not match specified or required material can also be easily highlighted in the digitized illustration on the analyzer in a discrepancy report for additional validation analysis before archiving or reporting. This report may be emailed from the analyzer while in the field or downloaded in the office for distribution. In step 127 the modified maps and linked verification data are archived. The final remediated reports can be stored on local networks or linked to document management or mechanical integrity applications for documentation purposes. This information is organized by system or equipment circuit, where the safe status of a system can easily be referenced and verified from the map reports and associated material analysis summaries. The detailed analyzer data files can also be stored onto optical, tape, magnetic or other storage media for long term archival purpose in a way that the analyzer can be reloaded for retesting of the same system or circuit due to maintenance replacement of components that once again require analysis. This archiving also allows for the creation of a standardized library of typical systems or groups of items requiring alloy analysis that can be used as is or copied and modified to best fit the actual new systems requiring alloy verification.

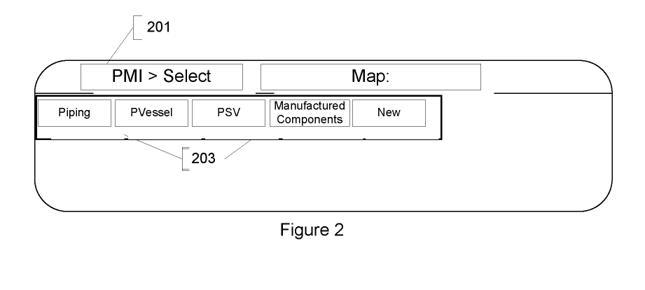

FIGS. 2 through 7 illustrate various different exemplary menus and maps from an alloy analyzer, in accordance with an embodiment of the present invention. FIG. 2 illustrates an exemplary PMI mode selection menu, in accordance with an embodiment of the present invention. In the present embodiment, the PMI selection menu is where the type of PMI project or activity is selected in order to provide access to the proper related information such as, but not limited to, proper manufacturer standards, predefined maps, categorized listings and templates, or examples for use as item group maps for identifying locations. A PMI Select button 201 brings up the choices of alloy verification projects and the associated item type libraries as project buttons 203.

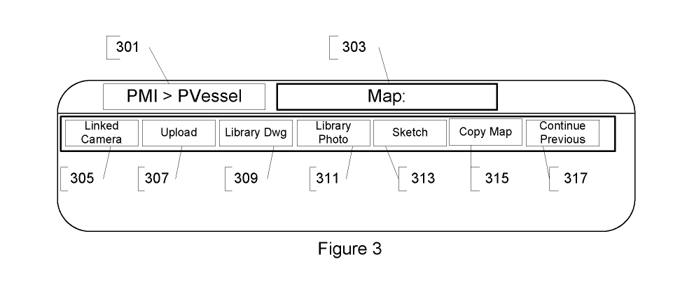

FIG. 3 illustrates an exemplary map selection menu, in accordance with an embodiment of the present invention. In the present embodiment, the map selection menu is where the digitized illustration of the items to be analyzed is loaded prior to conducting the alloy verification activities. The type of PMI verification project with type of equipment and associated item type library is indicated by a PMI box 301. Selecting a map button 303 brings up the map selection menu. Various selection buttons in the map selection menu enable the user to choose between different methods for obtaining a map. A linked camera button 305 enables the user to choose a map from a camera that is directly linked to or accessible to the analyzer. An upload button 307 enables the user to select the map from digitized illustration files from a thumb drive or other storage device. A library drawing button 309 enables the user to select the map from CAD, ISO or manufacturing drawings stored on the analyzer by type of PMI project and then by equipment type. A library photo button 311 enables the user to choose the map from standard photos, manufacturer photos or other typical photos of equipment by PMI project then by equipment type. A sketch button 313 opens a CAD or drawing application on the analyzer in which the user may create a drawing or illustration as needed during the verification process. A copy map button 315 provides a method of browsing and making a copy of a previously created map as is or for modification to fit the current group of items for verification. A continue previous button 317 enables the user to retrieve a previous started or completed map to continue a project. Continue previous button 317 may also be used to open a map generated from an application prior to the alloy verification work.

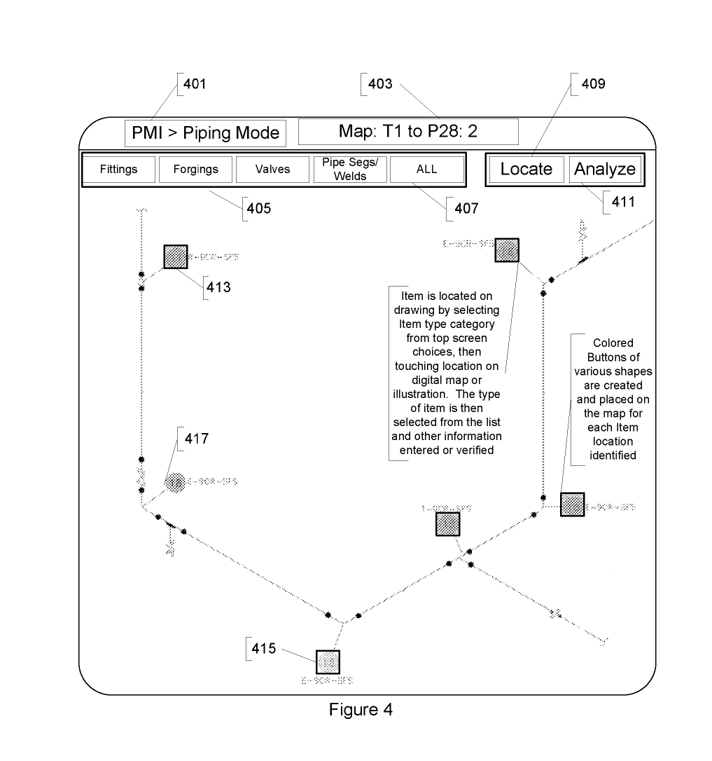

FIG. 4 illustrates an exemplary piping map, in accordance with an embodiment of the present invention. In the present embodiment, the piping map is selected in the analyzer application preloaded from an existing Inspection Isometric Drawing, illustrating fitting locations that are located, matching, and non-matching on the drawing. The type of PMI verification project with type of equipment and associated item type library is indicated by a PMI box 401, and a map box 403 shows what portion of the system or group is being verified along with a sequence number if more than one sequence is required. Map box 403 may be double clicked to load another map. Subcategory buttons 405 enable the user to select different item types or subcategories from pre-populated item listings. The item associated with the selected category is highlighted on the map, and only selected item type locations are shown on the map. Selecting an ALL button 407 shows all item types. A locate button 409 activates a locate mode to identify and enter relevant information for each location and item type. Once locations are defined, an analyze button 411 may be selected to perform alloy analysis on a selected item. An item is located on the map by selecting an item type category from subcategory buttons 405 then touching a location on the map. The type of item is then selected from the list and additional information may be entered or verified. Colored buttons of various shapes and sizes are created and placed on the map for each item location identified. For example, without limitation, in the present embodiment, a location with missing alloy analysis data 413 is highlighted with a red shaded box, and a location with non-matching alloy analysis 415 is highlighted with a yellow box. A location with complete alloy analysis data 417 with a proper match to the specified material has no highlighting.

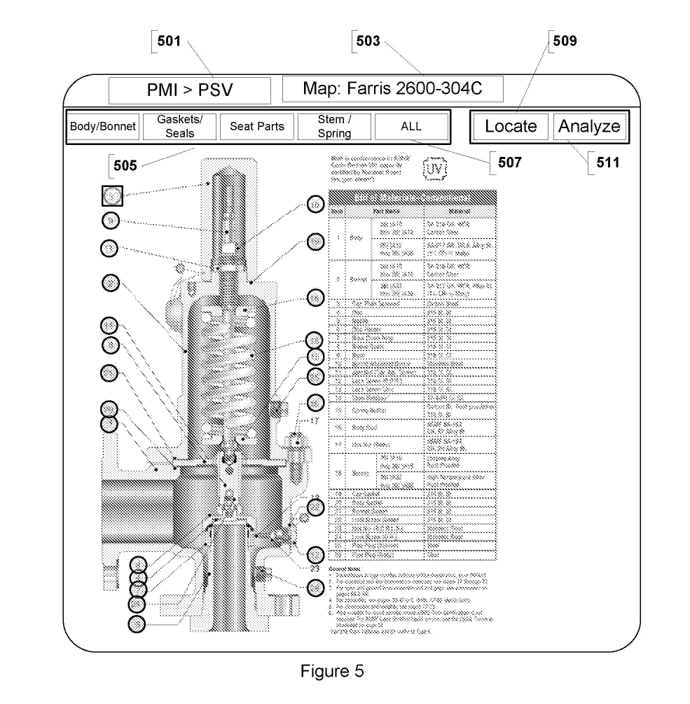

FIG. 5 illustrates an exemplary PSV Map, in accordance with an embodiment of the present invention. In the present embodiment, the PSV map is selected in the analyzer application preloaded from manufacturer-supplied illustrations. The map comprises a PMI box 501, a map box 503, subcategory buttons 405, an ALL button 507, a locate button 509, and an analyze button 511, similarly to the map illustrated by way of example in FIG. 4. Map box 503 shows the name of the manufacturer drawing for the selected PSV. The map illustrates color-coded locations by item type category, and other functionality. The illustration illustrates some of the functionality of the PMI PSV Mode Alloy Analysis application. The functionality of the PSV mode is the same as the Piping mode in FIG. 4, except that the groups of components and available components in each group are named to correspond to a PSV.

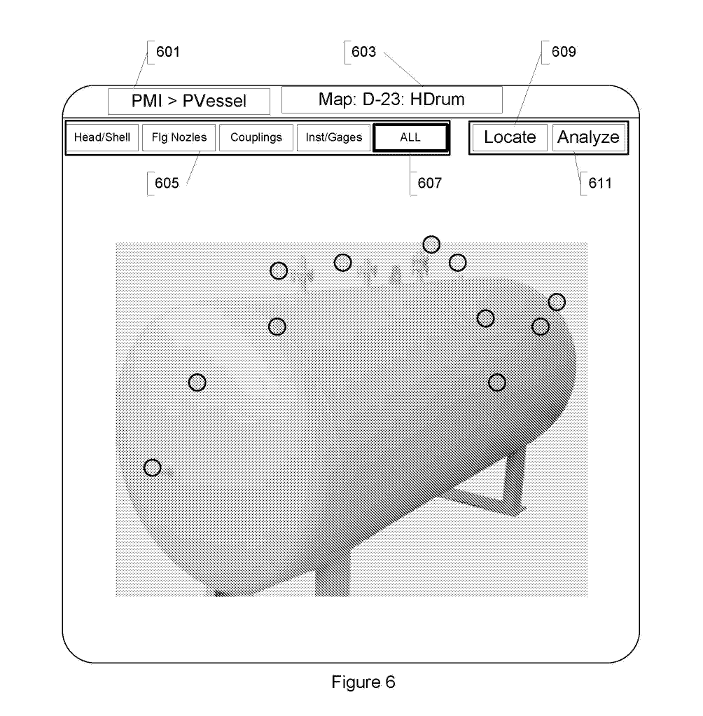

FIG. 6 illustrates an exemplary Pressure Vessel Map created in Pressure Vessel PMI mode utilizing a vessel photo that was taken with an integrated, accessible, or connected digital camera, in accordance with an embodiment of the present invention. The photo can also be selected in the analyzer application from preloaded manufacturer or generic supplied illustrations or previously obtained photographs of the actual vessel. The map comprises a PMI box 601, a map box 603, subcategory buttons 605, an ALL button 607, a locate button 609, and an analyze button 611, similarly to the maps illustrated by way of example in FIGS. 4 and 5. Map box 603 shows the name of the field acquired photo. This photomap illustrates color-coded locations by item type category, and other functionality. The illustration describes some of the functionality of the PMI Pressure Vessel Mode Alloy Analysis application. The functionality of the Pressure Vessel Mode is the same as the Piping mode in FIG. 4, except that the groups of components and available components in each group are named to correspond to a vessel.

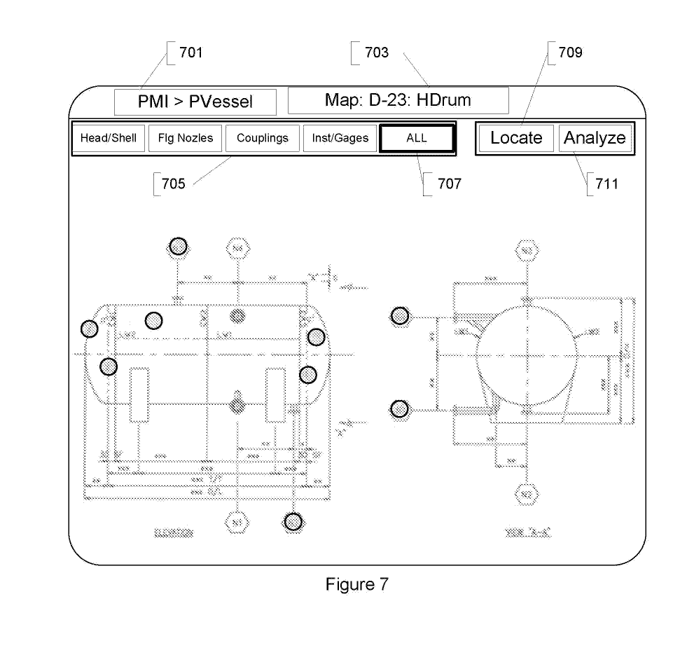

FIG. 7 illustrates an exemplary Pressure Vessel Map utilizing a generic vessel drawing preloaded for the specific vessel type, in accordance with an embodiment of the present invention. The map comprises a PMI box 701, a map box 703, subcategory buttons 705, an ALL button 707, a locate button 709, and an analyze button 711, similarly to the maps illustrated by way of example in FIGS. 4, 5 and 6. Map box 703 shows the name of the preloaded manufacturer drawing for the selected pressure vessel. The map illustrates color-coded locations by item type category, and other functionality.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

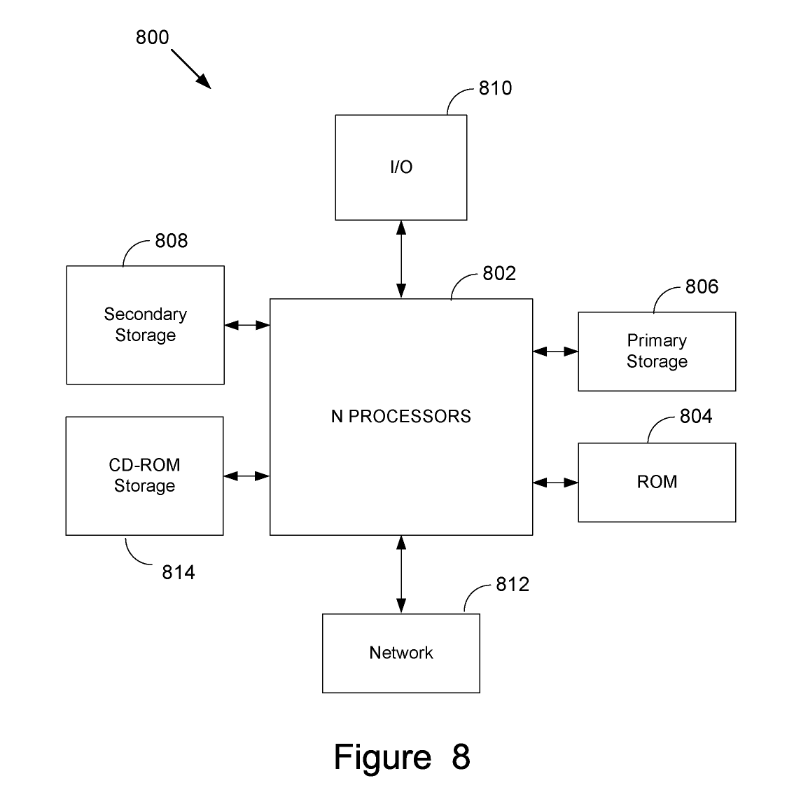

FIG. 8 illustrates a typical computer system that, when appropriately configured or designed, can serve as a computer system in which the invention may be embodied. The computer system 800 includes any number of processors 802 (also referred to as central processing units, or CPUs) that are coupled to storage devices including primary storage 806 (typically a random access memory, or RAM), primary storage 804 (typically a read only memory, or ROM). CPU 802 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 804 acts to transfer data and instructions uni-directionally to the CPU and primary storage 806 is used typically to transfer data and instructions in a bi-directional manner. Both of these primary storage devices may include any suitable computer-readable media such as those described above. A mass storage device 808 may also be coupled bi-directionally to CPU 802 and provides additional data storage capacity and may include any of the computer-readable media described above. Mass storage device 808 may be used to store programs, data and the like and is typically a secondary storage medium such as a hard disk. It will be appreciated that the information retained within the mass storage device 808, may, in appropriate cases, be incorporated in standard fashion as part of primary storage 806 as virtual memory. A specific mass storage device such as a CD-ROM 814 may also pass data uni-directionally to the CPU.

CPU 802 may also be coupled to an interface 810 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 802 optionally may be coupled to an external device such as a database or a computer or telecommunications or internet network using an external connection as shown generally at 812, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA.

Having fully described at least one embodiment of the present invention, other equivalent or alternative methods of providing a process and system for collecting and managing alloy verification information according to the present invention will be apparent to those skilled in the art. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A system comprising:
means for analyzing alloy composition of parts in a mechanical system;
means for storing a representation of the mechanical system and an item type listing with parts and specifications for the parts;
means for displaying at least part of the representation comprising a group of parts to validate;
means for selecting a location of a part on the displayed representation for analysis; and
means for linking analysis data from the analyzing means and specifications of the part to the selected location of the displayed representation, thereby transforming the representation to a representation comprising at least the analysis data and the specifications.

2. The system as recited in claim 1, further comprising means for selecting an item type of the selected location and linking to the selected location for determining analysis requirements.

3. The system as recited in claim 1, further comprising means for coding locations on the displayed representation for simplifying location of specific parts.

4. The system as recited in claim 1, further comprising means for indicating on the displayed representation a mismatch between analysis data and specifications.

5. The system as recited in claim 1, further comprising means for archiving the representation and linked location data.

6. The system as recited in claim 1, further comprising means for generating reports.

7. The system as recited in claim 1, further comprising means for capturing a representation of the mechanical system.

8. The system as recited in claim 1, further comprising means for drawing a representation of the mechanical system.

9. A method comprising:
steps for providing an alloy analyzer for analyzing composition of parts in a mechanical system;
steps for providing a computing device at least comprising computer readable memory and a display;
steps for storing a representation of the mechanical system and an item type listing with parts and specifications for the parts;
steps for displaying at least part of the representation comprising a group of parts to validate;
steps for selecting a location of a part on the displayed representation for analysis; and
steps for linking analysis data from the alloy analyzer and specifications of the part to the selected location of the displayed representation, thereby transforming the representation to a representation comprising at least the analysis data and the specifications.

10. The method as recited in claim 9, further comprising steps for selecting an item type of the selected location and linking to the selected location for determining analysis requirements.

11. The method as recited in claim 9, further comprising steps for coding locations on the displayed representation for simplifying location of specific parts.

12. The method as recited in claim 9, further comprising steps for indicating on the displayed representation a mismatch between analysis data and specifications.

13. The method as recited in claim 9, further comprising steps for archiving the representation and linked location data.

14. The method as recited in claim 9, further comprising steps for generating reports.

15. The method as recited in claim 9, further comprising steps for capturing a representation of the mechanical system.

16. The method as recited in claim 9, further comprising steps for drawing a representation of the mechanical system.

17. A computer program product residing on or being distributed across one or more computer readable mediums having a plurality of instructions stored thereon which, when executed by one or more associated processors, cause the one or more processors to:
store a representation of a mechanical system and an item type listing with parts and specifications for the parts;
display at least part of the representation comprising a group of parts to validate;
select a location of a part on the displayed representation for analysis;
select an item type of the selected location and link to the selected location for determining analysis requirements;
link analysis data from an alloy analyzer and specifications of the part to the selected location of the displayed representation; and
indicate on the displayed representation a mismatch between analysis data and specifications, thereby transforming the representation to a representation comprising at least the analysis data and the specifications.

18. The computer program product as recited in claim 17, further comprising instructions causing the one or more processors to capture a representation of the mechanical system.

19. The computer program product as recited in claim 17, further comprising instructions causing the one or more processors to enable drawing a representation of the mechanical system.

20. The computer program product as recited in claim 17, further comprising instructions causing the one or more processors to code locations on the displayed representation for simplifying location of specific parts.
